(19) United States
(12) Patent Application Publication
(10) Pub. No.: US 2024/0166068 A1
(43) Pub. Date: May 23, 2024

(54) Mobile Charging Device

(71) Applicant: Ron La Vigne, Wasilla, AK (US)

(72) Inventor: Ron La Vigne, Wasilla, AK (US)

(21) Appl. No.: 18/456,610

(22) Filed: Aug. 28, 2023

Related U.S. Application Data
(60) Provisional application No. 63/427,239, filed on Nov. 22, 2022.

(51) Int. Cl. B60L 53/57; B60L 53/16; B60L 53/30; B60L 53/302; B60L 53/66

(52) U.S. Cl. CPC B60L 53/57; B60L 53/16; B60L 53/302; B60L 53/305; B60L 53/66; B60L 2200/36; B60L 2240/622; B60L 2250/16

(57) ABSTRACT

A novel mobile charging device is disclosed to charge and warm stranded electric vehicles. The device comprises a multifunctional commercial truck that functions as a tow truck and a three-phase internal combustion power source for charging electric vehicles. The mobile charging device also comprises a plurality of charging ports, positioned on the sides of the truck. The charging ports are designed to accommodate any make or model of electric vehicle. Thus, the mobile charging device is useful for helping prevent electric vehicle owners from being stranded for long periods of time without battery charge.

### CROSS-REFERENCE TO RELATED APPLICATION

The present application claims priority to, and the benefit of, U.S. Provisional Application No. 63/427,239, which was filed on Nov. 22, 2022, and is incorporated herein by reference in its entirety.

### FIELD OF THE INVENTION

The present invention relates generally to the field of mobile charging devices. More specifically, the present invention relates to a mobile charging system and device that is designed to warm up and charge all types of electric vehicles. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in mobile charging devices. Generally, despite electric vehicles becoming increasingly common, locating charging stations while traveling can be difficult. Further, batteries losing their charge while away from home can leave people stranded in dangerous locations. In cold climate regions, the battery life of the user's electric vehicle can be depleted sooner, as the battery can be affected by the cold climate. Additionally, purchasing a tow truck just to retrieve an electric vehicle with a dead battery can be frustrating.

Accordingly, a need remains for a mobile electric vehicle power charging device that has the ability to charge multiple electric vehicles and can be moved to a desired location, as needed. Further, the mobile electric vehicle power charging device can also operate as a tow truck, if a vehicle needs to be towed. Thus, the mobile charging device allows electric vehicle charging anytime, anywhere. Further, the mobile charging device allows electric vehicles and passengers to have a safe recovery when running out of electricity. The mobile charging device is typically the only option benefiting fleets, businesses and private owners, not excluding military and government entities. Thus, the mobile charging device leads to a decrease in insurance claims in several categories and is a huge asset to electric vehicle manufacturers.

Therefore, there exists a long-felt need in the art for a mobile charging device that provides users with a mobile tow truck-style vehicle that can respond to stranded electric vehicles with no battery charge. There is also a long-felt need in the art for a mobile charging device that allows users to warm up and charge their electric vehicle via a charging port on the truck. Further, there is a long-felt need in the art for a mobile charging device that comprises multiple charging ports to accommodate any make or model of electric vehicle. Moreover, there is a long-felt need in the art for a device that functions as a standard tow truck if a tow is needed for any vehicle. Further, there is a long-felt need in the art for a mobile charging device that prevents electric vehicle owners from being stranded long term while traveling and is essential to cold climate regions. Finally, there is a long-felt need in the art for a mobile charging device that is a safe, equitable alternative for warming and charging all types of electric vehicles.

The subject matter disclosed and claimed herein, in one embodiment thereof, comprises a mobile charging device. The device is a multifunctional commercial truck designed to charge and warm stranded electric vehicles. The multifunctional commercial truck is similar to a tow truck but also comprises a three-phase internal combustion power source that allows the factory battery chargers for electric vehicles to go mobile. When towing a vehicle, the commercial truck draws the stranded electric vehicle into its enclosed cargo area. The mobile charging device also comprises a plurality of charging ports positioned on the sides of the truck. The charging ports are designed to allow the mobile charging device to provide emergency service warm up and charging capabilities to stranded electric vehicles. Further, the charging ports are designed to accommodate any make or model of electric vehicle. Thus, the mobile charging device is useful for helping prevent electric vehicle owners from being stranded for long periods of time without battery charge.

In this manner, the mobile charging device of the present invention accomplishes all of the foregoing objectives and provides users with a multifunctional commercial truck that provides mobile charging for stranded electric vehicles. The device can accommodate any make or model of electric vehicle. The device can also function as a standard tow truck with its enclosed cargo area.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mobile charging device. The device is a multifunctional commercial truck designed to charge and warm stranded electric vehicles. The multifunctional commercial truck has an enclosed cargo area for towing vehicles and a three-phase internal combustion power source for charging electric vehicles. The mobile charging device also comprises a plurality of charging ports, positioned on the sides of the truck and designed to accommodate any make or model of electric vehicle. Thus, the mobile charging device is useful for helping prevent electric vehicle owners from being stranded for long periods of time without battery charge.

The growing deployment of electric vehicles creates a need for widespread electrical chargers that are conveniently and strategically located at points of interest. In one embodiment, the mobile charging device is utilized with a vehicle, which acts as a mobile charging platform. The vehicle can be a commercial truck, a tow truck, a van, or other suitable vehicle that can be transported, and which can then be dispatched on an “as-needed” basis to meet a requesting driver of an electric vehicle at a pre-arranged location for a charging session. In every embodiment of the invention, the mobile charging device is a motorized vehicle, not a device that is passively carried or pulled. In one embodiment, the mobile charging device comprises a commercial truck with an enclosed cargo area for towing the electric vehicles, if needed.

In one embodiment, the enclosed cargo area can be any suitable shape and size as is known in the art, as long as at least one electric vehicle can fit within when needed. Specifically, the enclosed cargo area can be raised and lowered, similar to a tow truck, to allow the electric vehicle to enter and exit the cargo area. The controls for raising and lowering the cargo area can be located within the cab area. Once secure within the cargo area, the electric vehicle can be towed to another location. Further, in one embodiment, the electric vehicle can be positioned within the cargo area and simultaneously charged while being transported to another location.

In one embodiment, the commercial truck of the mobile charging device comprises a chassis (or body), which is substantially supported by approximately four to six wheels. Wheels can be selected to permit the commercial truck to travel on road and/or off road, as desired. The chassis can additionally include an operator's compartment or cab, from which the internal combustion power source and charging ports can be operated. The operator's compartment can include windows or viewing ports to permit the operator/driver to see outside the compartment. In one particular embodiment of the invention, the operator's compartment is mounted to the front portion of the chassis. Additionally, a steering mechanism is provided within the operator's compartment to enable an operator to steer the wheels and to proceed in the forward and reverse directions.

Additionally, the mobile charging device comprises a three-phase internal combustion power source, which can be any of a group of devices in which the reactants of combustion (oxidizer and fuel) and the products of combustion serve as the working fluids of the engine. Such an engine gains its energy from heat released during the combustion of the nonreacted working fluids, the oxidizer-fuel mixture. Internal-combustion engine, examples include gasoline engines, diesel engines, gas-turbine engines, and rocket-propulsion systems. Generally, the commercial truck of the mobile charging device comprises a diesel engine.

In another embodiment, the commercial truck comprises a plurality of charging ports or electrical sockets for connection to an electric vehicle to be charged or to an external charging source. For example, the charging ports permit the electric vehicles to be attached via their charging cords to charge the electric vehicle. The plurality of charging ports are positioned on an outside of the truck cab, or any other suitable position as is known in the art. Generally, the charging ports are universal charging ports allowing any suitable make and model of electric vehicle to be charged. In another embodiment, multiple charging ports can be included with the mobile charging device, each designed to charge a specific make and model of electric vehicle, such that different makes and models of electric vehicles can be charged.

This invention also contemplates the need for the mobile charging device to carry different charger types and charging cables to manage compatibility with different makes of electric vehicles. Specifically, electric vehicle designs usually differ in make and model of electric vehicles as each may be equipped with different battery technology, different charging mechanisms, battery management systems, capacity, etc. Thus, each electric vehicle has a charging protocol that may differ from one another such as, in the charging rate, ambient temperature, etc. The mobile charging device controls these protocols and monitors the amount of energy used in recharging the electric vehicle, the time of the charging sequence, etc. Thus, the mobile charging device provides the ability to match brand specific electric vehicles with brand compatible charging units.

In one embodiment, the mobile charging device would comprise a Level-1, Level-2, Level-3, or Level-4 charger. A Level-2 charger would take at least an hour to provide sufficient charge for the electric vehicle to travel between 25 to 50 miles for an hour charge. A Level-3 DCFC fast charger may only require 15 minutes of charging time to provide the equivalent amount of charge as a Level-2 charger taking two hours. A Level-4 charger would be even faster. All Level-1, Level-2, Level-3, and/or Level-4 chargers and associated equipment and accessories are compliant with current governing standards of design and use, and as standards evolve and are adopted, this invention assumes compliance with all necessary standards and governing bodies.

In one embodiment, the mobile charging device comprises arrow lights or other suitable lights that illuminate the mobile charging device and the electric vehicles being charged nearby, so as to warn and alert traffic. Thus, users can safely charge their vehicles without worry of traffic not being able to see their vehicle and/or traffic hitting their vehicle while charging. The lights can be any suitable shape and size as is known in the art. Further, the lights can blink, flash, strobe, change tempo, change color, etc.

Further, electricity is produced from an internal combustion triple phase generator and then dispensed through the charging ports to charge the vehicle batteries. Specifically, the mobile charging device described herein has the ability to operate continuously with no external recharging connection, such as the electrical grid, as well as having the ability to recharge other separate electrical vehicles requiring a charge, in any remote or urban location. Accordingly, the mobile charging device consists of a vehicle or other transportable platform/container that is equipped with charging ports powered by alternators (i.e., electricity generators) that run on gasoline, diesel fuel, or another motor-powered source.

In one embodiment, communications between the mobile charging device and the electric vehicle are accomplished using software applications, texts, emails, phone calls, etc. In another embodiment, the mobile charging device includes a software mobile application for providing communication and control from the mobile charging device through a wireless communications interface. In general, these apps are software applications running on smart devices with wireless connectivity and access to the internet. The mobile charging device is continuously tracked, and its itineraries are refreshed continuously as submitted by the operator/driver on the software mobile application. When a driver submits a routing plan via the mobile app that is connected to the internet cloud or other wireless communications network/environment, a user can determine whose operating areas coincide with the user's position. The mobile charging device can also be tracked via GPS. Further, the software application can provide for electronic recordkeeping and payment processing. However, payment mechanisms are universally available from third parties and other forms of payment processing can be utilized as well, such as the use of on-site magnetic card readers, smart chip card readers, and even online internet data entry through third-party portals for payment processing.

In one embodiment, multiple mobile charging devices are utilized to allow at least one mobile charging device to be available around the clock, seven days a week and 24 hours a day. The mobile charging device can be continuously monitored and tracked via the software application and GPS. Specifically, the mobile application provides position information using various applications such as GPS, cell tower triangulation techniques, or using location sensitive beaconing technologies, such as Apple Computer's Bluetooth app iBeacon, to locate the electric vehicle. Accordingly, users can make any requests for charging directly on the software application or directly with the driver. Thus, bookings between the mobile charging device and the user may be made either by manual interaction between a driver or through the app.

Thus, the mobile charging device provides a roving charging station on a moving platform, such as a commercial truck equipped with an enclosed cargo area and a three-phase internal combustion power source for charging. It will be appreciated by those skilled in the art having the benefit of this disclosure that the mobile charging device provides a tremendous utility to the electric vehicle driver while reducing the need for, and cost of installing fixed electric vehicle charging stations that can never keep up with the growth of electric vehicle adoption. Mobile electric vehicle charging stations also remove or greatly reduce range anxiety or the fear of running out of battery charge far away from fixed electric vehicle charging stations. By enabling electric vehicle charging stations to be mobile, drivers need not delineate from taking direct routes to their intended destinations merely to be close to fixed electric vehicle charging stations that are out of their intended trip paths.

In yet another embodiment, the mobile charging device comprises a plurality of indicia.

In yet another embodiment, a method of warming and charging a stranded electric vehicle is disclosed. The method includes the steps of providing a mobile charging device comprising a commercial truck with an enclosed cargo area, internal combustion power source, and multiple charging ports. The method also comprises driving the commercial truck to the stranded electric vehicle. Further, the method comprises securing the charging cable of the electric vehicle to the charging port of the device. The method also comprises charging the electric vehicle via the device. Finally, the method comprises towing the electric vehicle within the enclosed cargo area, if necessary.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the mobile charging device of the present invention showing the device traveling on a road in accordance with the disclosed architecture;

FIG. 2 illustrates a side perspective view of one embodiment of the mobile charging device of the present invention showing the charging ports in accordance with the disclosed architecture;

FIG. 3 illustrates a front perspective view of one embodiment of the mobile charging device of the present invention showing the blinking arrow lights on top of the truck cab in accordance with the disclosed architecture;

FIG. 4 illustrates a side perspective view of one embodiment of the mobile charging device of the present invention showing how a stranded vehicle can be towed in the enclosed cargo area of the truck in accordance with the disclosed architecture;

FIG. 5 illustrates a front perspective view of one embodiment of the mobile charging device of the present invention showing the device in use, charging an electric vehicle in accordance with the disclosed architecture; and

FIG. 6 illustrates a flowchart showing the method of charging a stranded electric vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a mobile charging device that provides users with a mobile tow truck-style vehicle that can respond to stranded electric vehicles with no battery charge. There is also a long-felt need in the art for a mobile charging device that allows users to warm up and charge their electric vehicle via a charging port on the truck. Further, there is a long-felt need in the art for a mobile charging device that comprises multiple charging ports to accommodate any make or model of electric vehicle. Moreover, there is a long-felt need in the art for a device that functions as a standard tow truck if a tow is needed for any vehicle. Further, there is a long-felt need in the art for a mobile charging device that prevents electric vehicle owners from being stranded long term while traveling and is essential to cold climate regions. Finally, there is a long-felt need in the art for a mobile charging device that is a safe, equitable alternative for warming and charging all types of electric vehicles.

The present invention, in one exemplary embodiment, is a novel mobile charging device. The device is a multifunctional commercial truck designed to charge and warm stranded electric vehicles, as well as tow an electric vehicle as needed. When towing a vehicle, the commercial truck draws the stranded electric vehicle into its enclosed cargo area. The mobile charging device also comprises a plurality of charging ports positioned on the sides of the truck. The charging ports are designed to accommodate any make or model of electric vehicle. Thus, the mobile charging device is useful for helping prevent electric vehicle owners from being stranded for long periods of time without battery charge. The present invention also includes a novel method of charging a stranded electric vehicle. The method includes the steps of providing a mobile charging device comprising a commercial truck with an enclosed cargo area, internal combustion power source, and multiple charging ports. The method also comprises driving the commercial truck to the stranded electric vehicle. Further, the method comprises securing the charging cable of the electric vehicle to the charging port of the device. The method also comprises charging the electric vehicle via the device. Finally, the method comprises towing the electric vehicle within the enclosed cargo area, if necessary.

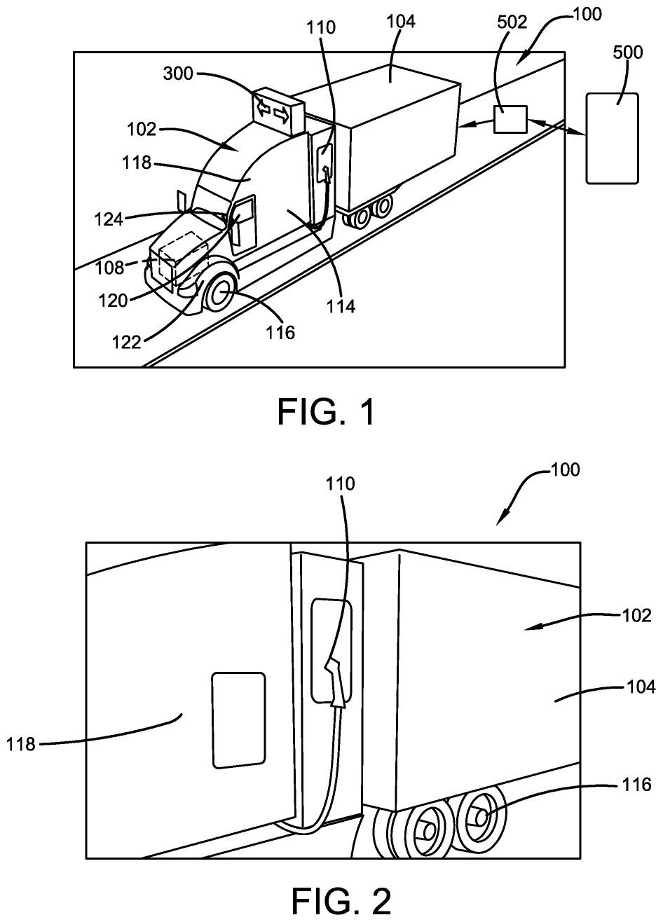

Referring initially to the drawings, FIG. 1 illustrates a perspective view of one embodiment of the mobile charging device 100 of the present invention. In the present embodiment, the mobile charging device 100 comprises a multifunctional commercial truck 102 with an enclosed cargo area 104 and an internal combustion power source 108 that charges and warms a stranded electric vehicle 106. The mobile charging device 100 also comprises a plurality of charging ports 110 positioned on the sides 112 of the truck 102 and designed to accommodate any make or model of electric vehicle 106. Thus, the mobile charging device 100 is useful for helping prevent electric vehicle owners from being stranded for long periods of time without battery charge.

The growing deployment of electric vehicles 106 creates a need for widespread electrical chargers that are conveniently and strategically located at points of interest. In one embodiment, the mobile charging device 100 is utilized with a vehicle, which acts as a mobile charging platform. The vehicle can be a commercial truck, a tow truck, a van, or other suitable vehicle that can be transported, and which can then be dispatched on an “as-needed” basis to meet a requesting driver of an electric vehicle 106 at a pre-arranged location for a charging session. In every embodiment of the invention, the mobile charging device 100 is a motorized vehicle, not a device that is passively carried or pulled. In one embodiment, the mobile charging device 100 comprises a commercial truck 102 with an enclosed cargo area 104 for towing the electric vehicles 106, if needed.

Generally, the commercial truck 102 of the mobile charging device 100 comprises a chassis 114 (or body), which is substantially supported by approximately four, six, or ten wheels 116 (i.e., standard wheel numbers for weight restrictions). Wheels 116 can be selected to permit the commercial truck 102 to travel on road and/or off road, as desired. The chassis 114 can additionally include an operator's compartment or cab 118 from which the internal combustion power source 108 and charging ports 110 can be operated. The operator's compartment 118 can include windows 120 or viewing ports to permit the operator/driver to see outside the compartment 118. In one particular embodiment of the invention, the operator's compartment 118 is mounted to the front portion 122 of the chassis 114. Additionally, a steering mechanism 124 is provided within the operator's compartment 118 to enable an operator to steer the wheels 116 and to proceed in the forward and reverse directions.

Furthermore, electricity is produces from an internal combustion triple phase generator 108 and then dispensed through the charging ports 110 to charge the electric vehicle's batteries. Specifically, the mobile charging device 100 described herein has the ability to operate continuously with no external recharging connection, such as the electrical grid, as well as having the ability to recharge other separate electrical vehicles 106 requiring a charge in any remote or urban location. Accordingly, the mobile charging device 100 consists of a vehicle 102 or other transportable platform/container that is equipped with charging ports 110 powered by alternators (i.e., electricity generators) that run on gasoline, diesel fuel, or another motor-powered source.

As shown in FIG. 2, the mobile charging device 100 comprises an internal combustion triple phase generator power source 108, which can be any of a group of devices in which the reactants of combustion (oxidizer and fuel) and the products of combustion serve as the working fluids of the engine. Such an engine gains its energy from heat released during the combustion of the nonreacted working fluids, the oxidizer-fuel mixture. Internal-combustion engine, examples include gasoline engines, diesel engines, gas-turbine engines, and rocket-propulsion systems. Generally, the commercial truck 102 of the mobile charging device 100 comprises a diesel engine. The device 100 can also include trailers, skids, track rigs, etc., as needed.

Furthermore, the commercial truck 102 comprises a plurality of charging ports 110 or electrical sockets for connection to an electric vehicle 106 to be charged or to an external charging source. For example, the charging ports 110 permit the electric vehicles 106 to be attached via their charging cords 200 to charge the electric vehicle 106. The plurality of charging ports 110 are positioned on an outside of the truck cab 118, or any other suitable position as is known in the art. Generally, the charging ports 110 are universal charging ports, allowing any suitable make and model of electric vehicle 106 to be charged. In another embodiment, multiple charging ports 110 can be included with the mobile charging device 100, each designed to charge a specific make and model of electric vehicle 106, such that different makes and models of electric vehicles 106 can be simultaneously charged.

This invention also contemplates the need for the mobile charging device 100 to carry different charger types and charging cables to manage compatibility with different makes of electric vehicles 106. Specifically, electric vehicle 106 designs usually differ in make and model of electric vehicles 106 as each may be equipped with different battery technology, different charging mechanisms and battery management systems, capacity, etc. Thus, each electric vehicle 106 has a charging protocol that may differ from one another, such as in the charging rate, ambient temperature, etc. The mobile charging device 100 controls these protocols and monitors the amount of energy used in recharging the electric vehicle 106, the time of the charging sequence, etc. Thus, the mobile charging device 100 provides the ability to match brand-specific electric vehicles 106 with brand-compatible charging units.

In one embodiment, the mobile charging device 100 would comprise a Level-1, Level-2, Level-3, or Level-4 charger. A Level-2 charger would take at least an hour to provide sufficient charge for the electric vehicle 106 to travel between 25 to 50 miles for an hour charge. A Level-3 DCFC fast charger may only require 15 minutes of charging time to provide the equivalent amount of charge as a Level-2 charger taking two hours. A Level-4 charger would take even less time. All Level-1, Level-2, Level-3, and/or Level-4 chargers and associated equipment and accessories are compliant with current governing standards of design and use, and as standards evolve and are adopted, this invention assumes compliance with all necessary standards and governing bodies.

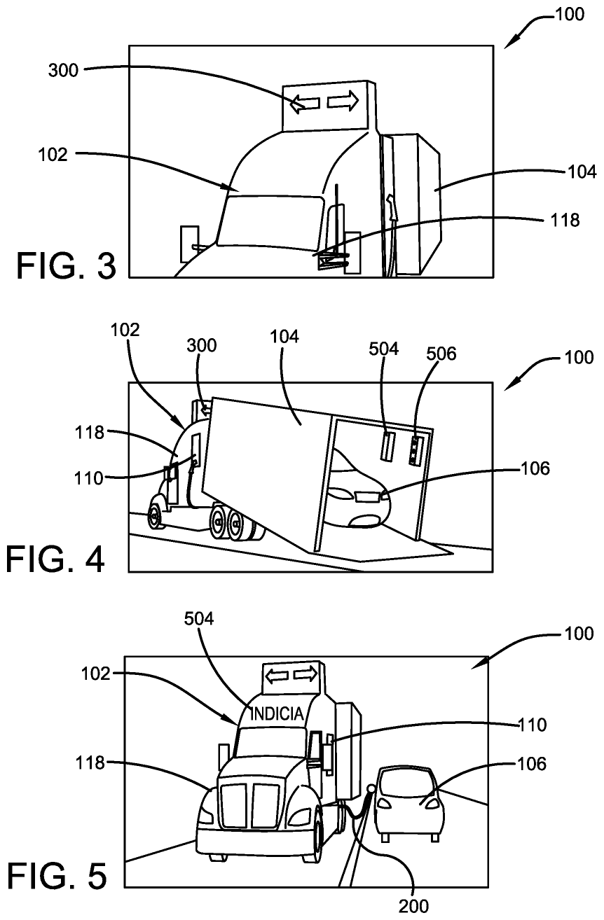

As shown in FIG. 3, the mobile charging device 100 comprises arrow lights 300 or other suitable lights that illuminate the mobile charging device 100 and the electric vehicles 106 being charged nearby, so as to warn and alert traffic. Thus, users can safely charge their vehicles 106 without worry of traffic not being able to see their vehicle 106 and/or traffic hitting their vehicle 106 while charging. The lights 300 can be any suitable shape and size as is known in the art. Further, the lights 300 can blink, flash, strobe, change tempo, change color, etc.

As is shown in FIG. 4, the enclosed cargo area 104 can be any suitable shape and size as is known in the art, as long as at least one electric vehicle 106 can fit within when needed. Specifically, the enclosed cargo area 104 can be raised and lowered, similar to a tow truck, to allow the electric vehicle 106 to enter and exit the cargo area 104. The controls for raising and lowering the cargo area 104 can be located within the cab area 118. Once secured within the cargo area 104, the electric vehicle 106 can be towed to another location. Further, in one embodiment, the electric vehicle 106 can be positioned within the cargo area 104 and simultaneously charged while being transported to another location. Further, the cargo area 104 can include fire suppression systems 504 and dehumidifiers 506, to protect users dealing directly with disabled electric vehicles in a heated enclosure of the cargo area 104.

As shown in FIG. 5, communications between the mobile charging device 100 and the electric vehicle 106 are accomplished using software applications 500, texts, emails, phone calls, etc. In another embodiment, the mobile charging device 100 includes a software mobile application 500 for providing communications and control from the mobile charging device 100 through a wireless communications interface 502. In general, these apps are software applications running on smart devices with wireless connectivity and access to the internet. The mobile charging device 100 is continuously tracked and its itineraries are refreshed continuously as submitted by the operator/driver on the software mobile application 500. When a driver submits a routing plan via the mobile app 500 that is connected to the internet cloud or other wireless communications network/environment 502, a user can determine whose operating areas coincide with the user's position. The mobile charging device 100 can also be tracked via GPS. Further, the software application 500 can provide for electronic recordkeeping and payment processing. However, payment mechanisms are universally available from third parties and other forms of payment processing can be utilized as well, such as the use of on-site magnetic card readers, smart chip card readers, and even online internet data entry through third-party portals for payment processing.

In one embodiment, multiple mobile charging devices 100 are utilized to allow at least one mobile charging device 100 to be available around the clock, seven days a week and 24 hours a day. The mobile charging device 100 can be continuously monitored and tracked via the software application 500 and GPS. Specifically, the mobile application 500 provides position information using various applications such as GPS, cell tower triangulation techniques, or using location sensitive beaconing technologies, such as Apple Computer's Bluetooth app iBeacon, to locate the electric vehicle 106. Accordingly, users can make any requests for charging directly on the software application 500 or directly with the driver. Thus, bookings between the mobile charging device 100 and the user may be made either by manual interaction between a driver or through the app 500.

Thus, the mobile charging device 100 provides a roving charging station on a moving platform, such as a commercial truck 102, equipped with an enclosed cargo area 104 and a three-phase internal combustion power source 108 for charging. It will be appreciated by those skilled in the art having the benefit of this disclosure that the mobile charging device 100 provides a tremendous utility to the electric vehicle driver while reducing the need for, and cost of installing fixed electric vehicle charging stations that can never keep up with the growth of electric vehicle adoption. Mobile electric vehicle charging stations also remove, or greatly reduce, range anxiety or the fear of running out of battery charge far away from fixed electric vehicle charging stations. By enabling electric vehicle charging stations to be mobile, drivers need not delineate from taking direct routes to their intended destinations merely to be close to fixed electric vehicle charging stations that are out of their intended trip paths.

In yet another embodiment, the mobile charging device 100 comprises a plurality of indicia 504. The commercial truck 102 of the device 100 may include advertising, trademark, other letters, designs, or characters, printed, painted, stamped, or integrated into the truck 102, or any other indicia 504 as is known in the art. Specifically, any suitable indicia 504 as is known in the art can be included, such as, but not limited to, patterns, logos, emblems, images, symbols, designs, letters, words, characters, animals, advertisements, brands, etc., that may or may not be electric, charging, or brand related.

The haul and charge fleets that the mobile charging device 100 could benefit also included car carriers, and electric powered commercial vehicles could also be used to haul the mobile charging device 100 to stranded electric vehicles.

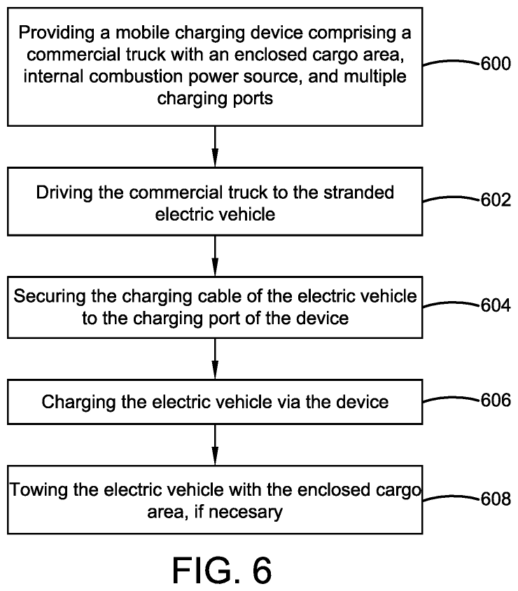

FIG. 6 illustrates a flowchart of the method of charging a stranded electric vehicle. The method includes the steps of at 600, providing a mobile charging device comprising a commercial truck with an enclosed cargo area, internal combustion power source, and multiple charging ports. The method also comprises at 602, driving the commercial truck to the stranded electric vehicle. Further, the method comprises at 604, securing the charging cable of the electric vehicle to the charging port of the device. The method also comprises at 606, charging the electric vehicle via the device. Finally, the method comprises at 608, towing the electric vehicle within the enclosed cargo area, if necessary.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “mobile charging device”, “charging device”, and “device” are interchangeable and refer to the mobile charging device 100 of the present invention.

Notwithstanding the foregoing, the mobile charging device 100 of the present invention can be of any suitable size and configuration as is known in the art without affecting the overall concept of the invention, provided that it accomplishes the above-stated objectives. One of ordinary skill in the art will appreciate that the mobile charging device 100 as shown in FIGS. 1-6 are for illustrative purposes only, and that many other sizes and shapes of the mobile charging device 100 are well within the scope of the present disclosure. Although the dimensions of the mobile charging device 100 are important design parameters for user convenience, the mobile charging device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile charging device that charges a stranded electric vehicle, the mobile charging device comprising:
a vehicle;
an internal combustion power source; and
a plurality of charging ports; and
wherein the internal combustion power source provides power to the plurality of charging ports to charge and warm a stranded electric vehicle;
wherein the vehicle is a motorized vehicle that is mobile; and
further wherein the mobile charging device prevents the stranded electric vehicle from being stranded for long periods of time without battery charge.

2. The mobile charging device of claim 1, wherein the vehicle is a commercial truck with an enclosed cargo area.

3. The mobile charging device of claim 2, wherein the enclosed cargo area can be raised and lowered, similar to a tow truck, to allow the stranded electric vehicle to enter and exit the enclosed cargo area.

4. The mobile charging device of claim 3, wherein the enclosed cargo area can be utilized to tow the stranded electric vehicle to another location.

5. The mobile charging device of claim 4, wherein the commercial truck comprises a chassis, which is substantially supported by approximately six wheels, and an operator's cab with windows and a steering wheel.

6. The mobile charging device of claim 5, wherein the internal combustion power source and the plurality of charging ports are operated from within the operator's cab, which is mounted to a front portion of the chassis.

7. The mobile charging device of claim 6, wherein electricity produced from an internal combustion triple phase generator is then transferred to a regulator and dispensed through the plurality of charging ports to charge an electric vehicle's batteries.

8. The mobile charging device of claim 7, wherein the internal combustion power source is a diesel engine.

9. The mobile charging device of claim 8, wherein the plurality of charging ports permit the electric vehicle to be attached via their charging cord, to charge the electric vehicle.

10. The mobile charging device of claim 9, wherein the plurality of charging ports are positioned on an outside of the operator's cab.

11. The mobile charging device of claim 10, wherein the plurality of charging ports are universal charging ports, allowing any suitable make and model of electric vehicle to be charged.

12. The mobile charging device of claim 11 further comprising a plurality of arrow lights that blink or flash for safety and a fire suppression system and dehumidifier to protect users.

13. The mobile charging device of claim 12, wherein communications between the mobile charging device and the electric vehicle are accomplished using software applications, texts, emails, or phone calls.

14. A mobile charging device that charges a stranded electric vehicle, the mobile charging device comprising:
a commercial truck with an enclosed cargo area;
an internal combustion power source;
a plurality of charging ports; and
a plurality of arrow lights that blink or flash for safety;
wherein the internal combustion power source provides power to the plurality of charging ports to charge and warm a stranded electric vehicle;
wherein the enclosed cargo area can be raised and lowered, similar to a tow truck, to allow the stranded electric vehicle to enter and exit the enclosed cargo area;
wherein the commercial truck comprises a chassis, which is substantially supported by approximately six wheels, and an operator's cab with windows and a steering wheel;
wherein the internal combustion power source and the plurality of charging ports are operated from within the operator's cab, which is mounted to a front portion of the chassis;
wherein electricity produced from an internal combustion triple phase generator is then transferred to a regulator and dispensed through the plurality of charging ports to charge an electric vehicle's batteries; and
further wherein the mobile charging device prevents the stranded electric vehicle from being stranded for long periods of time without battery charge.

15. The mobile charging device of claim 14, wherein the internal combustion power source is a diesel engine.

16. The mobile charging device of claim 14, wherein the plurality of charging ports are universal charging ports, allowing any suitable make and model of electric vehicle to be charged.

17. The mobile charging device of claim 14, wherein communications between the mobile charging device and the electric vehicle are accomplished using software applications, texts, emails, or phone calls.

18. The mobile charging device of claim 17, wherein a software mobile application provides communications and control from the mobile charging device through a wireless communications interface and utilizes GPS to track the commercial truck and the stranded electric vehicle.

19. The mobile charging device of claim 14 further comprising a plurality of indicia.

20. A method of charging a stranded electric vehicle, the method comprising the following steps:
providing a mobile charging device comprising a commercial truck with an enclosed cargo area, internal combustion power source, and multiple charging ports;
driving the commercial truck to the stranded electric vehicle;
securing the charging cable of the electric vehicle to the charging port of the device; and
charging the electric vehicle via the device.
